(19) United States
(12) Patent Application Publication
(10) Pub. No.: US 2007/0071831 A1
(43) Pub. Date: Mar. 29, 2007

(54) Product for the prevention and the treatment of grapevine infections and method of preparation thereof

(75) Inventor: Giuseppina Cerea, Rozzano (IT)

Correspondence Address: LUCAS & MERCANTI, LLP, 475 PARK AVENUE SOUTH, 15TH FLOOR, NEW YORK, NY, 10016, US

(73) Assignee: Vomm Impianti e Processi S.p.A., Rozzano (Milano) (IT)

(21) Appl. No.: 11/532,766

(22) Filed: Sep. 18, 2006

(30) Foreign Application Priority Data
Sep. 21, 2005 (IT) MI 2005A001751

(51) Int. Cl. A01N 59/20; A01N 65/00

(52) U.S. Cl. 424/638; 424/766

(57) ABSTRACT

A product is described for the prevention and/or treatment of grapevine infections, obtained by the partial or total neutralization of lees originating from winemaking processes, for example by means of alkali or alkali-earth metal oxides or hydroxides; such product generally has a pH comprised between 6.0 and 8.0 and a humidity content of 70% or less; a composition for the prevention and/or treatment of grapevine infections, comprising such product and a process for the preparation of the above-mentioned product, comprising the addition of lees originating from a winemaking process, having a pH generally of 3.0 or less, a basic reactant to bring its pH to a value of 6.0 or above and an optional concentration step to bring the humidity content of the product to a value of 70% or less, are also described.

### CROSS-REFERENCE TO RELATED APPLICATIONS

This patent application claims the benefit of priority from Italian Patent Application No. MI12005A001751 filed Sep. 21, 2005, the contents of which are incorporated herein by reference.

### FIELD OF APPLICATION

The present invention refers to a product against grapevine infections. More in particular, the invention refers to a product against downy mildew infections.

The invention also refers to a process for the production of a product against downy mildew infections according to the present invention and a method of use thereof.

### PRIOR ART

It is a well-known fact that Plasmopara viticola, or downy mildew, is a fungus of the Peronosporaceae family, which attacks grapevines. Downy mildew is one of the most severe and widespread diseases of grapevine, occurring mainly in humid and frequent summer rain geographical areas characterized by mild spring and summer seasons.

Downy mildew mostly invades the green parts of the plant manifesting itself on the leaves by way of peculiar “oil stain” patches, on the inflorescence by way of small “S”-shaped bunch stems, a dry rachis, and browning of the grapes on the bunch stems, followed by drying and finally detachment.

Although downy mildew does not cause the death of the affected plants, it can nevertheless cause a considerable fall in the quantity and quality of production, and sometimes even compromise an entire vintage.

Many chemical spray (copper-based products, Bordeaux mixture, mancozeb, Metiram, etc) and systemic (Dimetomorf and phenylamides) anti-mildew products are known for the protection of grapevines from downy mildew. In general, the spray products are applied onto the leaves of the grapevine and have a preventive function. The systemic products are able to penetrate the plant tissues and enter circulation. Among the spray products, the most widespread are the copper-based ones (for example copper sulfate, copper oxychloride and copper hydroxide) and they are the only ones admitted by the organic farming International legislation in force.

However, they suffer from the drawback of depositing and accumulating in the soil, where excess copper is harmful to the paedofauna, the population of earthworms and carabids, and can alter the microbiological and enzymatic composition of the soil, as well as its acidity. Moreover, because of their poor solubility, they must be applied at concentrations higher than those actually required. As the solubility depends on various environmental factors, it is difficult to predict the quantities that will need to be administered, which thus generates the risk of overloading the plant with the product, which can lead to phytotoxicity.

The opposite problem can also occur, that is, a shortage of product caused by copper precipitation by the action of thiols found on the surface of the leaves.

Finally, because of the poor adhesion of these products to the leaves, areas of the leaves may become exposed in the event of rain.

Moreover, despite most of the copper being removed during normal winemaking processes, it is not removed entirely and it thus gets transferred over to the wine, particularly in the case of red wines, where the skins remain in contact with the must for a long time.

Most of the products known in the sector for the prevention or treatment of Plasmopara viticola infections have the inconvenience of being harmful and/or toxic to the environment, to the plant itself and/or to man. In addition, because of their low and variable solubility, they must be applied in higher quantities than the quantities actually needed, with the consequent worsening of their harmful effects. Finally, such products often exhibit the problem of development of resistance, on the part of the fungus, to the product, making the latter useless.

Patent EP1048211 describes a process for the protection of plants against fungal infections, in particular Plasmopara viticola. The method consists in treating the plants with a mixture of a non chelated copper source, such as, for example Bordeaux mixture, copper carbonate, copper hydroxide, copper oxychloride and a poorly soluble calcium and/or zinc and/or manganese chelate. This way, the resulting soluble copper chelate is released gradually.

Alternative treatment methods have been sought to the use of the above-mentioned copper derivatives or systemic fungicides, in the attempt to reduce the toxicity towards plants, the environment and man.

For example, patent application JP61085303 describes a product for the prevention of plant diseases which contains as active ingredient a liquid obtained from a plant of the Cruciferae family incubated with a microorganism that causes mildew disease in the very same plant.

Patent application JP6024906 describes a product for the control of mildew disease based on carbon powder and a detergent produced using natural oil and fat as base material.

Patent application DE 4009990 describes a plant protection agent for the prevention and treatment of plant diseases of biotic origin comprising: 1) natural carboxylic acids or salts thereof and/or at least two amino acids or salts thereof, 2) purines and/or derivatives thereof and/or pyrimidines and/or derivatives thereof, and 3) vitamins, or derivatives or precursors thereof, in a weight ratio of 0.1-10:0.001-1:0.001-1. The mixing of this product with fermentation products derived from plants and plant residues, algae, animal residues, or microorganism-enriched mixtures, is recommended.

The technical problem underlying the present invention is that of providing a product against grapevine infections caused by fungi, such as for example downy mildew, or by other microorganisms, which is both effective and non-toxic towards the grapevine, the human body and the environment.

### SUMMARY OF THE INVENTION

Such a problem has been solved by providing an anti-microbial product for the prevention and/or the treatment of grapevine infections, in particular downy mildew, obtained from the partial or total neutralization of lees produced in winemaking processes.

Total or partial neutralization of the lees is preferably obtained by treating the lees with alkali or alkali-earth metal oxides or hydroxides, advantageously with potassium hydroxide.

The pH of the product is preferably comprised between 6.0 and 8.0.

The product according to the invention is obtained by a process comprising the steps of:
providing lees produced in a winemaking process, having a pH generally lower than 3.0,
adding to said lees a basic reactant to bring their pH to 6.0 or above.

Preferably, the process further involves a concentration step, to bring the humidity content of the product to 70% or less.

Such a concentration step can be carried out by heating the totally or partially neutralized lees and can be advantageously carried out by flowing a continuous flow of said totally or partially neutralized lees in the state of a thin turbulent layer, in contact with a heated wall.

In a preferred embodiment of the present invention a turbo-concentrator is used as concentrating apparatus.

Among this type of machines, the one produced and marketed by VOMM IMPIANTI E PROCESSI—Milano (Italia) was found to be particularly useful and advantageous Such machine essentially comprises a horizontal-axis cylindrical tubular body, closed at its opposed ends by end walls, having openings for the introduction of the lees and a co-current flow of dry air, a heating jacket to bring the inner wall of said tubular body to a set temperature, a bladed rotor, rotatably supported in the cylindrical tubular body, where it is put into rotation at a peripheral speed variable between 15 and 50 m/s.

When such apparatus is used, the process for obtaining the product according to the invention comprises the steps of:
feeding a continuous flow of the above-mentioned lees at a pH of 6.0 or above in a turbo-concentrator comprising a horizontal-axis cylindrical tubular body, closed at the opposed ends by end walls and having at least one opening for the introduction of said lees, at least one discharge opening, a bladed rotor rotatably supported in the cylindrical tubular body, where it is put into rotation at such a speed as to obtain a flow of finely divided particles of such lees, and a heating jacket to bring the inner wall of the cylindrical tubular body to a temperature of at least 110° C.,
centrifuging the lees particles against the inner wall of the cylindrical tubular body, thus forming a tubular and dynamic, highly turbulent fluid thin layer, which advances substantially in contact with said heated inner wall towards said at least one turbo-concentrator discharge opening, with concomitant production of water vapor,
continuously discharging a flow of said product for the prevention and/or treatment of grapevine infections through said at least one discharge opening.

By using a turbo-concentrator of the above-mentioned type, it is possible to carry out both the neutralization and the concentration step. In such case the process for obtaining the product according to the present invention is characterized by the fact of comprising the steps of:
feeding a continuous flow of lees originating from winemaking processes in the above-mentioned turbo-concentrator having a further opening for the introduction of at least one basic reactant and wherein the inner wall of the cylindrical tubular body is maintained at a temperature of at least 110° C.,
feeding a continuous flow of a basic reactant in the turbo-concentrator co-currently with said lees flow, centrifuging the lees and the basic reactant against the inner wall of the cylindrical tubular body, thus forming a tubular and dynamic, highly turbulent, fluid thin layer, wherein the lees and the reactant are mechanically maintained in close contact by means of the blades of the bladed rotor, and
reacting the lees and the reactant in the thin layer, while it advances substantially in contact with said heated inner wall towards said at least one discharge opening of the turbo-concentrator, with concomitant production of water vapor,
continuously discharging a flow of at least partially neutralized and concentrated lees through said at least one discharge opening.

Advantageously, a flow of hot dry air is fed into the turbo-concentrator co-currently with the lees flow; by doing so, the speed of vapor removal is increased.

The above-mentioned flow of dry air preferably has a flow rate of up to 10 Nm³ of air per liter of evaporated water.

The above-mentioned flow of basic reactant preferably consists of a flow of a concentrated alkali of alkali-earth metal oxide or hydroxide aqueous solution, advantageously potassium hydroxide.

The humidity content of the final product is preferably comprised between 30% and 60%.

Preferably, the temperature of the heating jacket is comprised between 140 e 240° C. and the residence time of the lees flow inside the turbo-concentrator is comprised between 1 and 10 minutes.

The product according to the present invention is a very dense but still pourable dark brown liquid.

Advantageously, the effect of the heat treatment of the method of the present invention is the elimination and/or damaging of any heat-sensitive and non heat-sensitive microorganisms that are potentially harmful to vineyards.

An excessive addition of basic reactant does not cause an excessive rise in the pH of the product according to the present invention because the tartaric acid naturally present in the lees converts into potassium tartrate, which exerts a buffering effect. The pH of the product will thus be of about 7.

The present invention also comprises a method of preventing or combating grapevine infections, which comprises the step of uniformly applying the above-described product on the grapevines after bringing its dry matter content to 20% or less by optional dilution with water.

The present application finally refers to the use of the lees originating from winemaking processes for the preparation of an anti-microbial product for the prevention and/or the treatment of grapevine infections, in particular downy mildew.

### BRIEF DESCRIPTION OF THE DRAWING

FIG. 1 is a cross-sectional view of a turbo-concentrator described in Example 1

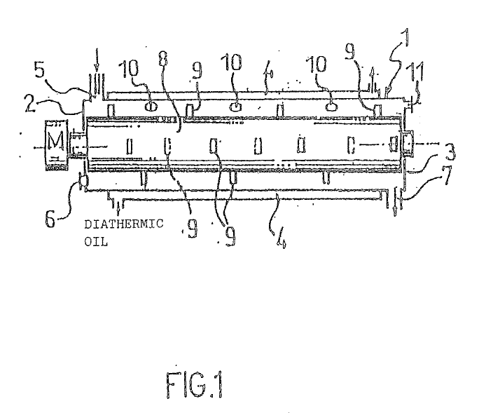

### DETAILED DESCRIPTION OF THE INVENTION

The present invention will be further described by reference to some embodiments given here for illustrative and non-limiting purposes.

### EXAMPLE 1

Lees obtained from the first filtering in a winemaking process was provided, exhibiting a light purple color, a consistency similar to honey and a pH of 2.72. Initial humidity was 89.2%.

A continuous flow of such lees was fed, with a flow rate of 100 kg/h in a turbo-concentrator having a cylindrical tubular body 1 having an inner diameter of 300 mm and having a bladed rotor 8 made to rotate at 700 rpm, while the temperature of the inner wall of the cylindrical tubular body 1 was being maintained at 220° C.

At the same time and co-currently with such lees flow, a continuous flow of 50% KOH was fed into the turbo-concentrator through the inlet openings 6 and 10, with a flow rate of 4.5 kg/h.

Starting from the inlet of the turbo-concentrator the lees flow is immediately mechanically dispersed into small particles, which are immediately centrifuged against the inner wall of the turbo-concentrator, where they form a dynamic, tubular thin layer.

In the meantime, a KOH aqueous solution entering through the opening 6 is finely atomized by the blades 9 of rotor 8, which also centrifuges the tiny droplets thus formed. These latter are thus incorporated in the dynamic, tubular, thin layer of lees particles, thus producing an instantaneous neutralization reaction. The contact with the heated wall at the same time causes the evaporation of a considerable amount of water.

Following a residence time of about 4 minutes in the turbo-concentrator, the lees that had reacted with the KOH solution was continuously discharged from opening 7. In the meanwhile, through opening 11 the vapor generated during the heat treatment was discharged. The temperature of the lees exiting the turbo-concentrator was of about 95° C., their pH is about 6.8 and they were in the form of a very dense dark brown liquid having a humidity content of 51%.

### EXAMPLE 2

The product obtained according to example 1 was diluted with water, mixing a part of product with ten parts of water and it was used to treat the grapevine plants.

The product thus diluted was applied by spraying on 70 grapevine plants arranged in 5 rows in a vineyard comprising approximately 1000 grapevine plants. The remaining plants were then treated with a conventional synthetic plant protection product (Metiram).

The treatments were carried out during the period between the beginning of March and the end of July, each time applying a quantity of 100 g of diluted product per plant. The same number of applications as those of the conventional plant protection product were carried out, at the same times.

At the end of the treatment none of the 70 plants treated with the product according to the invention exhibited signs of downy mildew attack, whereas 18% of the plants treated with the Metiram showed obvious signs of downy mildew infestation.

Without wishing to be bound by theory, the anti-microbial action, fungicidal in particular, of the product of the invention is conferred by certain substances that the grapevine itself produces in the attempt to fight the infection when it is attacked by downy mildew or other pathogenic microorganisms.

The anti-microbial product of the present invention is particularly effective when it is obtained by a process that involves the addition of potassium hydroxide because potassium is a very good fertilizer and a chemical element which interferes with the life cycle of the parasites of the grapevine (downy mildew included).

The anti-microbial action according to the present invention, because it is made starting from a natural substance, is not harmful to the environment, to the grapevine, to the soil, or to man. It also exhibits a near neutral pH, whereas conventional copper-based products usually exhibit a pH of about 5.5, and a pleasant smell.

As it does not constitute a source of harmful substances, there is no issue of avoiding the absorption of its components by the grapes. Therefore, and contrary to what happens in the treatments with traditional fungicides, there is no need to interrupt the treatment of the plant ten days prior to the vintage. The treatment can thus be continued up until the day of harvest, thus ensuring a greater protection from infections.

Advantageously, it can be distributed and transported at any concentration, in the dry to highly diluted form and optionally be diluted according to need in a variety of weight ratios, depending on the requirements, prior to use.

As the product exhibits in its composition a high content of potassium ions, an essential microelement for the health of the plant, it follows that any deposits/residues of the product absorbed by the soil beneath, are beneficial to the plant.

Moreover, the presence of potassium ions gives the wine obtained from the grapes treated with the product of the invention desirable nutritional characteristics. Potassium, in fact, is an antihypertensive. It therefore follows that the wine also would have beneficial effects on arterial pressure.

Other nutritional advantages of the wine, given by the treatment of the grapevines with the product of the invention, comprise the fact that it would also be more anticholesterolemic than traditional wines, thanks to the increased presence of veratrol, an antioxidant known for its beneficial effects against the risk of heart diseases, of which the product according to the invention is rich. The veratrol found in the product according to the invention is in fact absorbed by the plants that undergo the treatment and adds on to the one naturally present in grapes.

Moreover, the high saccharide content in its composition gives the product an improved clinging compared to the products known in the field, given by the action of the Van der Waals forces generated by the sugar molecules (hydrogen bonds). The product of the invention thus has the advantage of having a longer residence time on the leaves (or other site) onto which it is applied, even in the event of rain, and therefore exerts its action for a longer time compared to traditional products. The quantity of product that will need to be applied will thus be reduced.

In this respect, it has been calculated that the quantity of the product of the invention that will be necessary, as such, for a course of treatment (usually corresponding to an average of 10 applications), per plant, is 100 g. Considering that there are on average 3300 plants per hectare of land dedicated to grapevine cultivation, a 2000 hectare land would require 660 tonnes of product. This amount is considerably smaller that the quantities of conventional plant protection products usually used.

Thanks to its reddish-purplish color, given by the anthocyanic pigments, a plant on which the product of the invention has been uniformly applied, will reflect any radiation belonging to the red spectrum and will absorb the others instead. In particular, the absorption of the radiations of the green spectrum will be particularly beneficial to the plant thanks to their function in the photosynthesis reaction. Healthier and higher yielding plants will thus be obtained.

Finally, some preliminary experiments have shown that the product of the invention is effective not only against downy mildew infections but also against other plant diseases such as, in particular, corky bark, caused by the phytoplasm transmitted by the vector Scaphoideus titanus Ball, a Deltocefalinae plathopper.

In particular the product has been tested on 70 grapevine plants arranged on five rows in a vineyard wherein the remaining plants (more than 500) have been treated with a conventional synthetic plant protection product (Fenitrothion). The 70 plants treated with the product according to the invention were completely protected from corky bark, whereas the majority of the plants treated with conventional plant protection products was attacked.

1. Product for the prevention and/or treatment of grapevine infections, obtained by the partial or total neutralization of lees produced in winemaking processes.

2. Product according to claim 1, obtained from the partial or total neutralization of said lees with alkali or alkali-earth metal oxides or hydroxides, preferably with potassium hydroxide.

3. Product according to claim 1 having a pH comprised between 6.0 and 8.0.

4. Product according to claim 2 having a pH comprised between 6.0 and 8.0.

5. Anti-microbial product according to claim 1, having a humidity content of 70% or less, preferably comprised between 30 and 60%.

6. Anti-microbial product according to claim 4, having a humidity content of 70% or less, preferably comprised between 30 and 60%.

7. Composition for the prevention and/or treatment of grapevine infections, comprising a product according to claim 1.

8. Composition for the prevention and/or treatment of grapevine infections, comprising a product according to claim 6.

9. Composition according to claim 7, comprising at least one further active substance chosen from the group consisting of copper sulfate, copper oxychloride, copper hydroxide, mancozeb, Metiram, dimethomorf and phenylamide.

10. Composition according to claim 8, comprising at least one further active substance chosen from the group consisting of copper sulfate, copper oxychloride, copper hydroxide, mancozeb, Metiram, dimethomorf and phenylamide.

11. Process for the preparation of a product for the prevention and/or treatment of grapevine infections, comprising the steps of:
providing lees produced in a winemaking process, having a pH generally of 3.0 or less,
adding to said lees a basic reactant to bring its pH to a value of 6.0 or above.

12. Process according to claim 11, further comprising a concentration step, to bring the humidity content of the product to a 70% or less.

13. Process according to claim 12, wherein said concentration step is carried out by heating said lees having a pH of 6.0 or above.

14. Process according to claim 13, wherein said concentration step is carried out by flowing a continuous flow of said lees in the form of a thin turbulent layer, in contact with a heated wall

15. Process according to claim 14, comprising the steps of:
feeding a continuous flow of said lees having pH of 6.0 or above in a turbo-concentrator comprising a horizontal-axis cylindrical tubular body (1), closed at the opposed end by bottom ends (2,3) and having at least one opening (5) for the introduction of said lees, at least one discharge opening (7,11), a bladed rotor (8) rotatably supported in the cylindrical tubular body (1), where it is put into rotation at such a speed as to obtain a flow of finely divided particles of said lees, and a heating jacket (4) to bring the inner wall of the cylindrical tubular body to a temperature of at least 110° C.,
centrifuging the lees particles against the inner wall of the cylindrical tubular body (1), thus forming a thin tubular and dynamic, highly turbulent, fluid layer that advances substantially in contact with said heated inner wall towards said at least one discharge opening (7) of the turbo-concentrator, with concomitant production of water vapor,
continuously discharging a flow of said product for the prevention and/or treatment of grapevine infections through said at least one discharge opening (7).

16. Process according to claim 12, characterized in that it comprises the steps of:
feeding a continuous flow of lees originating from winemaking processes in a turbo-concentrator comprising a horizontal-axis cylindrical tubular body (1), closed at the opposed ends by bottom ends (2,3) and having openings (5,6,10) for the introduction of said lees and for the introduction of at least one basic reactant, at least one discharge opening (7, 11), a bladed rotor (8) rotatably supported in the cylindrical tubular body (1), where it is put into rotation at such a speed as to obtain a flow of finely divided particles of said lees, and a heating jacket (4) to bring the inner wall of the cylindrical tubular body (1) to a temperature of at least 110° C.,
feeding a continuous flow of a basic reactant in the turbo-concentrator co-currently with said lees flow, centrifuging the lees and the basic reactant against the inner wall of the cylindrical tubular body (1), thus forming a thin tubular and dynamic, highly turbulent, fluid layer, wherein the lees and the reactant are mechanically maintained in close contact by means of the blades (9) of the bladed rotor (8), and
reacting the lees and the reactant in the thin layer, while the latter advances substantially in contact with said heated inner wall towards said at least one discharge opening (7) of the turbo-concentrator, with concomitant production of water vapor,
continuously discharging a flow of at least partially neutralized and concentrated lees through at least one discharge opening (7).

17. Process according to claim 15, wherein the turbo-concentrator is fed, co-currently with the lees flow, a flow of hot dry air.

18. Process according to claim 16, wherein the turbo-concentrator is fed, co-currently with the lees flow, a flow of hot dry air.

19. Process according to claim 16, wherein said basic reactant consists of an alkali or alkali-earth metal oxide or hydroxide concentrated aqueous solution, preferably potassium hydroxide.

20. Process according to claim 15, wherein the humidity content of the final product is comprised between 30% and 60%.

21. Process according to claim 16, wherein the humidity content of the final product is comprised between 30% and 60%.

22. Process according to claims 15, wherein the temperature of the heating jacket is comprised between 140 and 240° C. and the residence time of the lees flow inside the turbo-concentrator is comprised between 1 and 10 minutes.

23. Process according to claims 16, wherein the temperature of the heating jacket is comprised between 140 and 240° C. and the residence time of the lees flow inside the turbo-concentrator is comprised between 1 and 10 minutes.

24. Method for preventing or combating grapevine infections, which comprises the step of uniformly applying the product according to claim 1 on grapevine plants, after its dry matter content has been brought to a value of 20% or less by optional dilution with water.

25. Method for preventing or combating grapevine infections, which comprises the step of uniformly applying the product according to claim 4 on grapevine plants, after its dry matter content has been brought to a value of 20% or less by optional dilution with water.

26. Method for preventing or combating grapevine infections, which comprises the step of uniformly applying the product according to claim 5 on grapevine plants, after its dry matter content has been brought to a value of 20% or less by dilution with water.

27. Method for preventing or combating grapevine infections, which comprises the step of uniformly applying the composition according to claim 7 on grapevine plants, after its dry matter content has been brought to a value of 20% or less by optional dilution with water.

28. Method for preventing or combating grapevine infections, which comprises the step of uniformly applying the composition according to claim 10 on grapevine plants, after its dry matter content has been brought to a value of 20% or less by optional dilution with water.
